(19) United States
(12) Patent Application Publication
(10) Pub. No.: US 2025/0276506 A1
(43) Pub. Date: Sep. 4, 2025

(54) MEDIUM TRANSPORT DEVICE, CORRUGATION UNIT, RECORDING DEVICE

(71) Applicant: SEIKO EPSON CORPORATION, Tokyo (JP)

(72) Inventor: Riku MAEDA, SHIOJIRI-SHI (JP)

(21) Appl. No.: 19/062,358

(22) Filed: Feb. 25, 2025

(30) Foreign Application Priority Data
Feb. 29, 2024 (JP) 2024-029618

(51) Int. Cl. B31F 1/22; B65H 29/70

(52) U.S. Cl. CPC B31F 1/22; B65H 29/70; B65H 2801/27

(57) ABSTRACT

A medium transport device includes a corrugation unit including a plurality of corrugation members that come into contact with a medium transported in a transport direction and impart a corrugated shape to the medium, and a transport path through which the medium is transported. When a direction along a surface of the medium and intersecting the transport direction is a width direction, and a direction intersecting the surface of the medium is an intersecting direction, a position of the corrugation member in the width direction and a position thereof in the intersecting direction are adjustable.

The present application is based on, and claims priority from JP Application Serial Number 2024-029618, filed Feb. 29, 2024, the disclosure of which is hereby incorporated by reference herein in its entirety.

### BACKGROUND

### 1. Technical Field

The present disclosure relates to a medium transport device that transports a medium. Further, the present disclosure relates to a corrugation unit that imparts a corrugated shape to a medium. Further, the present disclosure relates to a recording device that performs recording on a medium.

### 2. Related Art

A sheet discharge device disclosed in JP 2021-100874 A includes a plurality of corrugation members. The plurality of corrugation members deform a sheet into a corrugated shape in a width direction by coming into contact with the sheet, thereby enhancing a property of proceeding straight of the sheet.

Further, in the sheet discharge device disclosed in JP 2021-100874 A, some of the plurality of corrugation members are provided so as to be displaceable along the width direction, and positions that come into contact with the sheet can be changed according to a size of the sheet.

When a corrugated shape is formed in a sheet, it is required that a degree of freedom in forming the corrugated shape is further increased.

### SUMMARY

A medium transport device of the present disclosure for solving the above-described problems is a medium transport device including a corrugation unit including a plurality of corrugation members that come into contact with a medium transported in a transport direction and impart a corrugated shape to the medium, and a transport path through which the medium is transported, wherein when a direction along a surface of the medium and intersecting the transport direction is a width direction, and a direction intersecting the surface of the medium is an intersecting direction, a position of the corrugation member in the width direction and a position in the intersecting direction are adjustable.

Additionally, a corrugation unit of the present disclosure is a corrugation unit including a plurality of corrugation members that come into contact with a medium transported in a transport direction and impart a corrugated shape to the medium, wherein when a direction along a surface of the medium and intersecting the transport direction is a width direction, and a direction intersecting the surface of the medium is an intersecting direction, a position of the corrugation member in the width direction and a position in the intersecting direction are adjustable.

Further, a recording device of the present disclosure includes a recording unit configured to perform recording on a medium, and the above medium transport device.

### BRIEF DESCRIPTION OF THE DRAWINGS

FIG. 1 is a diagram illustrating a medium transport path of a printer.

FIG. 2 is a diagram illustrating the medium transport path of the printer.

FIG. 3 is a perspective view of a corrugation unit in a mounted state.

FIG. 4 is a perspective view of a mounting frame for mounting the corrugation unit.

FIG. 5 is a front view of the corrugation unit in the mounted state.

FIG. 6 is an enlarged view of a vicinity of a discharge roller pair in FIG. 5.

FIG. 7 is a cross-sectional view taken along line B-B in FIG. 5.

FIG. 8 is a cross-sectional view taken along line A-A in FIG. 5.

FIG. 9 is a side view of a corrugation member.

FIG. 10 is a diagram illustrating a corrugation formed in a medium.

FIG. 11 is a diagram illustrating a corrugation formed in a medium.

FIG. 12 is a diagram illustrating a corrugation formed in a medium.

FIG. 13 is a diagram illustrating a configuration for making a corrugation member detachable.

FIG. 14 is a diagram illustrating a configuration for switching a height direction position of a corrugation member.

FIG. 15 is a diagram illustrating a configuration for switching a height direction position of the corrugation member.

FIG. 16 is a diagram illustrating a configuration for switching a height direction position of a corrugation member.

FIG. 17 is a diagram illustrating a configuration for switching a width direction position of the corrugation member.

FIG. 18 is a diagram illustrating the configuration for switching the width direction position of the corrugation member.

FIG. 19 is a block diagram illustrating a control system of the printer.

### DESCRIPTION OF EMBODIMENTS

Hereinafter, the present disclosure will be described in brief.

A medium transport device according to a first aspect is a medium transport device including a corrugation unit including a plurality of corrugation members that come into contact with a medium transported in a transport direction and impart a corrugated shape to the medium, and a transport path through which the medium is transported, wherein when a direction along a surface of the medium and intersecting the transport direction is a width direction, and a direction intersecting the surface of the medium is an intersecting direction, a position of the corrugation member in the width direction and a position in the intersecting direction are adjustable.

According to the aspect, the position of the corrugation member in the width direction and the position in the intersecting direction are adjustable, thus when a corrugated shape is formed in the medium, it is possible to further increase a degree of freedom in forming the corrugated shape. This makes it possible to more appropriately transport the medium.

A second aspect is an aspect dependent on the first aspect, wherein the corrugation unit includes a supporting member that is a member for supporting the corrugation member and is movable in the width direction and the intersecting direction, and a fixing member for fixing the supporting member.

According to the aspect, the positions of the corrugation member in the width direction and the intersecting direction can be appropriately adjusted and held by the supporting member and the fixing member.

A third aspect is an aspect dependent on the second aspect, wherein the corrugation unit includes a shaft that extends along the width direction, the shaft supporting the corrugation member together with the supporting member, and the corrugation member changes a position in contact with the medium by rotating around the shaft.

According to the aspect, the corrugation member is configured to change the position in contact with the medium by rotating around the shaft, and is configured to regulate posture by the shaft and the supporting member, thus the position coming into contact with the medium of the corrugation member is stabilized. Accordingly, a corrugated shape can be formed in the medium more appropriately.

A fourth aspect is an aspect dependent on the third aspect, wherein the corrugation member and the supporting member are engaged with each other by an engagement shaft provided on one side and an engagement groove provided on another side, and leeway is provided between the engagement shaft and the engagement groove.

According to the aspect, the leeway is provided between the engagement shaft and the engagement groove, thus it is possible to prevent the engagement shaft from applying strong force to the engagement groove when the supporting member is displaced in the intersecting direction. Thus, deformation of the supporting member or the corrugation member can be suppressed.

A fifth aspect is an aspect dependent on the first aspect, wherein the corrugation unit includes a transport roller that is a roller driven by a driving source and transports the medium.

In the configuration in which the corrugation member imparts a corrugated shape to the medium, transport resistance is generated in the medium. According to the aspect, the corrugation unit includes the transport roller that is the roller driven by the driving source and transports the medium, thus it is possible to appropriately transport the medium even when transport resistance is generated in the medium by the corrugation member.

Note that the aspect may also be dependent on any one of the above first to fourth aspects, not only on the above first aspect.

A sixth aspect is an aspect dependent on the fifth aspect, wherein the transport roller and the corrugation member overlap each other in the transport direction when viewed from the width direction.

According to the aspect, the transport roller and the corrugation member overlap each other in the transport direction when viewed from the width direction, thus the transport roller applies transport force to the medium at a position close to the corrugation member. As a result, it is possible to appropriately transport the medium even when transport resistance is generated in the medium by the corrugation member.

A seventh aspect is an aspect dependent on any one of the first to sixth aspect, wherein the corrugation member is attachable to and detachable from the corrugation unit.

According to the aspect, the corrugation member is attachable to and detachable from the corrugation unit, thus the number of corrugation members can be adjusted, and a degree of freedom in adjusting a corrugated shape to be imparted to the medium is improved.

An eighth aspect is an aspect dependent on any one of the first to sixth aspects, wherein the plurality of corrugation members include a first corrugation member coming into contact with a first surface of the medium and a second corrugation member coming into contact with a second surface of the medium opposite to the first surface.

According to the aspect, the plurality of corrugation members include the first corrugation member coming into contact with the first surface of the medium and the second corrugation member coming into contact with the second surface of the medium opposite to the first surface, thus the degree of freedom in adjusting a corrugated shape to be imparted to the medium is improved.

Note that the aspect may be dependent not only on any one of the first to sixth aspects but also on the seventh aspect.

A ninth aspect is an aspect dependent on the eighth aspect, wherein the corrugation member is attachable to and detachable from the corrugation unit.

According to the aspect, the corrugation member is attachable to and detachable from the corrugation unit, thus the number of corrugation members can be adjusted, and the degree of freedom in adjusting a corrugated shape to be imparted to the medium is further improved.

A tenth aspect is an aspect dependent on any one of the first to sixth aspects, wherein a plurality of the corrugation members include a right corrugation member positioned on a right side with respect to a center position in the width direction of the medium, and a left corrugation member positioned on a left side with respect to the center position, and the right corrugation member and the left corrugation member are provided so as to approach and separate from each other in the width direction.

According to the aspect, since the right corrugation member and the left corrugation member are provided so as to approach and separate from each other in the width direction, the right corrugation member and the left corrugation member can be disposed at positions constantly symmetrical with respect to the center position in the width direction. As a result, a corrugated shape can be appropriately imparted to the medium.

Note that the aspect may be dependent not only on the above first to sixth aspects but also on any one of the seventh to ninth aspects.

An eleventh aspect is an aspect dependent on the eighth aspect, wherein a plurality of at least one of the first corrugation members and the second corrugation members are provided along the width direction, and positions thereof in the intersecting direction change in conjunction with each other.

According to the aspect, the plurality of at least one of the first corrugation members and the second corrugation members are provided along the width direction, and the positions thereof in the intersecting direction change in conjunction with each other, thus a corrugated shape can be appropriately imparted to the medium.

Note that the aspect may be dependent not only on the above eighth aspect but also on the above ninth or tenth aspect.

A twelfth aspect is an aspect dependent on the first aspect including a frame constituting a base body of the device, wherein the corrugation unit is attachable to and detachable from the frame.

According to the aspect, the corrugation unit is attachable to and detachable from the frame, thus it is possible to reduce an installation space of the device by removing the corrugation unit when unnecessary, and usability is improved.

A corrugation unit according to a thirteenth aspect is a corrugation unit including a plurality of corrugation members that come into contact with a medium transported in a transport direction and impart a corrugated shape to the medium, wherein when a direction along a surface of the medium and intersecting the transport direction is a width direction, and a direction intersecting the surface of the medium is an intersecting direction, a position of the corrugation member in the width direction and a position in the intersecting direction are adjustable.

According to the aspect, the position of the corrugation member in the width direction and the position in the intersecting direction are adjustable, thus when a corrugated shape is formed in the medium, it is possible to further increase the degree of freedom in forming the corrugated shape. This makes it possible to more appropriately transport the medium.

A medium transport device according to a fourteenth aspect is a medium transport device including a transport path through which a medium is transported, and includes a mounting portion from which the corrugation unit according to the thirteenth aspect is detachable.

According to the aspect, by mounting the corrugation unit to the mounting portion, operational effects of the above thirteenth aspect can be obtained. Additionally, the corrugation unit is attachable to and detachable from the mounting portion, thus it is possible to reduce the installation space of the device by removing the corrugation unit when unnecessary, and usability is improved.

A recording device according to a fifteenth aspect includes a recording unit configured to perform recording on a medium, and the medium transport device according to the first or fourteenth aspect.

According to the aspect, in the recording device including the recording unit that performs recording on the medium, operational effects of the above first or fourteenth aspect can be obtained.

Note that the medium transport device included in the aspect may be not only the above first or fourteenth aspect, but may be any one of the second to twelfth aspects.

Hereinafter, the present disclosure will be described in detail.

Hereinafter, an inkjet printer 1 that performs recording by ejecting ink, which is an example of liquid, onto a medium, such as recording paper, will be described as an example of a recording device. Hereinafter, the inkjet printer 1 will be abbreviated as printer 1.

Note that the printer 1 can be regarded as a medium transport device 50 from the perspective of transporting the medium. In this case, the printer 1 includes the medium transport device 50 and a line head 12 which is an example of a recording unit described below. However, the entire device of the printer 1 including the line head 12 may be regarded as the medium transport device 50.

An X-Y-Z coordinate system illustrated in each drawing is an orthogonal coordinate system, and a Y-axis direction is a medium width direction and is a device depth direction. In the embodiment, among side surfaces constituting a periphery of a device body 2, a side surface in a +Y direction is a back surface, and a side surface in a −Y direction is a front surface.

An X-axis direction is a device width direction, and a +X direction is a left side and an −X direction is a right side as viewed by an operator of the printer 1.

A Z-axis direction is a vertical direction, that is, a device height direction, a +Z direction is an upward direction, and a −Z direction is a downward direction.

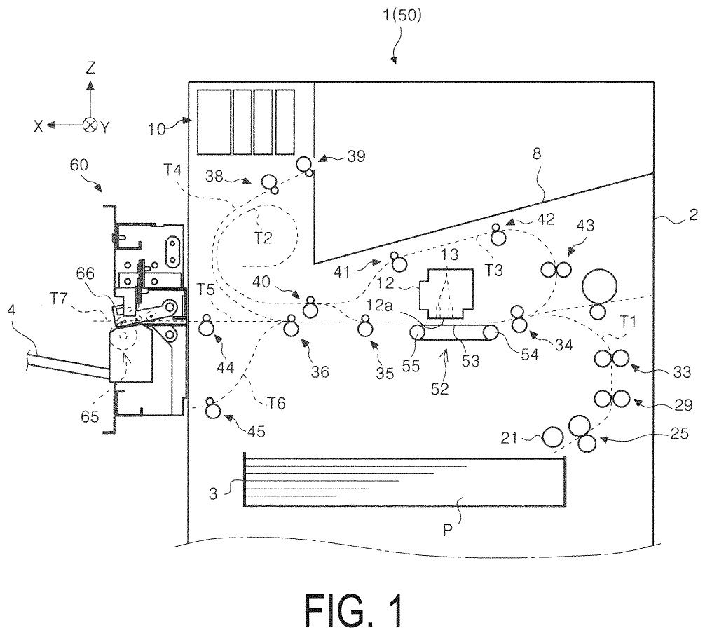

Hereinafter, a direction in which the medium is sent may be referred to as “downstream” and an opposite direction may be referred to as “upstream”. In FIG. 1, the medium transport path is illustrated by a dashed line. In the printer 1, the medium is transported through the medium transport path illustrated by the dashed line.

The printer 1 includes a medium cassette 3 at a lower portion of the device main body 2 including the line head 12 described below. A reference sign P denotes the medium accommodated in the medium cassette 3.

A pick roller 21 that sends out the accommodated medium in the −X direction is provided for the medium cassette 3. Further, a feed roller pair 25 that feeds the medium sent out by the pick roller 21 further downstream is provided for the medium cassette 3. Note that a plurality of medium cassettes (not illustrated) are further provided below the medium cassette 3. Additionally, a pick roller (not illustrated) and a feed roller pair (not illustrated) are provided for each of the plurality of medium cassettes (not illustrated).

Note that, in the present specification, unless otherwise specified, it is assumed that a “roller pair” includes a drive roller driven by a power source such as a motor, and a driven roller that rotates in a driven manner in contact with the drive roller.

A reference sign T1 denotes a feeding path for the medium that is sent out from the medium cassette 3 and reaches a transport roller pair 34. The medium sent out from the medium cassette 3 receives feed force from transport roller pairs 29 and 33 and is sent to the transport roller pair 34. The medium receiving the feed force from the transport roller pair 34 is sent to a recording position between the line head 12 and a transport belt 53, that is, facing the line head 12.

The line head 12 performs recording by ejecting ink, which is an example of liquid, from a nozzle 13 provided at a nozzle surface 12a. In the embodiment, the line head 12 is an ink ejection head in which a plurality of the nozzles 13 that eject the ink are disposed to cover an entire area in the medium width direction, and is configured as an ink ejection head that can perform recording over the entire width of the medium without moving in the width direction of the medium. However, the ink ejection head is not limited thereto, and may be a type that is mounted on a carriage and ejects ink while moving in the medium width direction.

The line head 12 according to the embodiment employs a piezo element, which is a piezoelectric element whose volume changes when a voltage is applied. A drive waveform of the piezo element is controlled so that a movement of a meniscus of the nozzle 13 can be controlled and a size and ejection speed of ejected ink droplets can be controlled.

In the embodiment, the plurality of nozzles 13 include a plurality of the nozzles 13 that eject yellow ink, a plurality of the nozzles 13 that eject magenta ink, a plurality of the nozzles 13 that eject cyan ink, and a plurality of the nozzles 13 that eject magenta ink.

Next, the transport belt 53 is an endless belt that is wound around a first roller 54, which is a driving roller, and a second roller 55, which is a driven roller, and rotates when the first roller 54 is driven by a motor (not illustrated). The medium is transported to a position facing the line head 12 while being adsorbed to a belt surface of the transport belt 53. The first roller 54, the second roller 55, and the transport belt 53 constitute a belt unit 52.

The medium on which recording is performed by the line head 12 is sent to either a transport roller pair 36 or a transport roller pair 40 by a transport roller pair 35 positioned downstream of the transport belt 53. A path switching flap (not illustrated) is provided near a downstream section of the transport roller pair 35, and the medium receiving the feed force from the transport roller pair 35 is sent to any one of the transport roller pair 36 and the transport roller pair 40 by this path switching flap.

When double-sided recording is not performed, the medium is sent from the transport roller pair 35 toward the transport roller pair 36.

Downstream of the transport roller pair 36, the transport path branches into three discharge paths T4, 15, and T6. A flap (not illustrated) that switches a transport destination of the medium is provided near a downstream section of the transport roller pair 36.

When the discharge path T4 is selected, the medium is discharged toward a discharge tray 8 through the discharge path T4. The discharge path T4 is provided with a transport roller pair 38 and a transport roller pair 39.

When the discharge path T5 is selected, the medium is discharged in the +X direction through the discharge path T5. At this time, as long as a corrugation unit 60 to be described later is mounted, the medium is discharged to the discharge tray 4 in a state in which a corrugated shape is formed by the corrugation unit 60. A reference sign T7 denotes a transport path in the corrugation unit 60. Note that the discharge path T5 is provided with a transport roller pair 44.

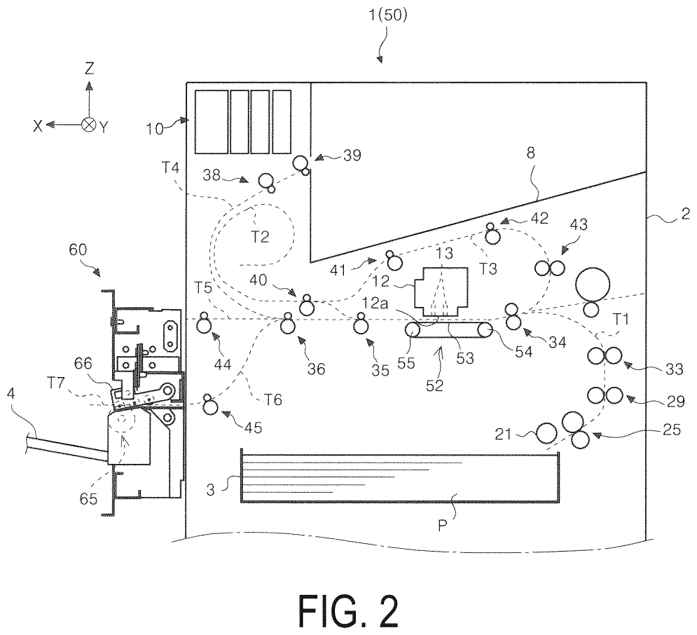

When the discharge path T6 is selected, the medium is discharged in the +X direction through the discharge path T6. At this time, as illustrated in FIG. 2, as long as the corrugation unit 60 to be described later is mounted, the medium is discharged to the discharge tray 4 in a state in which a corrugated shape is formed by the corrugation unit 60. Note that the discharge path T6 is provided with a transport roller pair 45.

On a left side surface of the printer 1, a post-processing device (not illustrated) can be mounted instead of the corrugation unit 60, and when this post-processing device is mounted, the medium is sent to the post-processing device via the discharge path T6. Examples of the post-processing include binding processing using a binding needle, punching processing, and the like.

When double-sided recording is performed, the medium is sent from the transport roller pair 35 to the transport roller pair 40 and enters a switchback path T2. Thereafter, a rotation direction of the transport roller pair 40 is switched, the medium enters a reversal path T3, and is sent to the transport roller pair 34 by the transport roller pairs 41, 42, and 43.

A reference sign 10 denotes an ink accommodation portion serving as a liquid accommodation portion that accommodates ink before ejection. Ink ejected from the line head 12 is supplied from the ink accommodation portion 10 to the line head 12 via a tube (not illustrated). The ink accommodation portion 10 accommodates black, yellow, magenta, and cyan inks as an example.

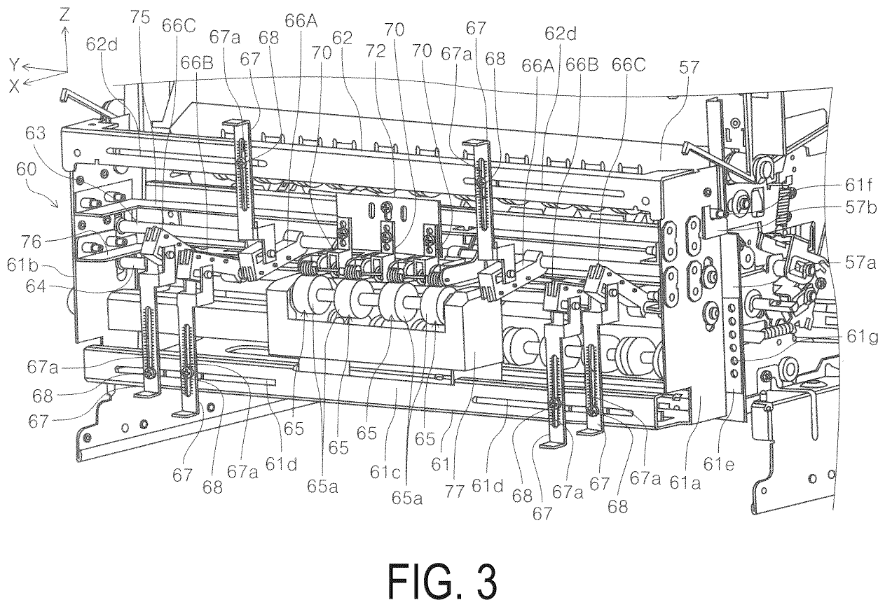

Next, the corrugation unit 60 will be described in detail with reference to FIG. 3 and subsequent drawings.

The corrugation unit 60 forms a corrugated shape in the medium to increase rigidity thereof, suppresses curling or sagging when the medium is discharged, and improves a stacking state, and in the embodiment, is attachable to and detachable from the printer 1.

As illustrated in FIG. 3, the corrugation unit 60 includes a base frame 61 as a base body. The base frame 61 includes side frame portions 61a and 61b spaced apart from each other in the Y-axis direction, and the side frame portions 61a and 61b form surfaces parallel to an X-Z plane. The side frame portions 61a and 61b are provided with a fixed portion 61e so as to form a surface parallel to a Y-Z plane. The fixed portion 61e can be fixed to a mounting frame 57 by a screw (not illustrated).

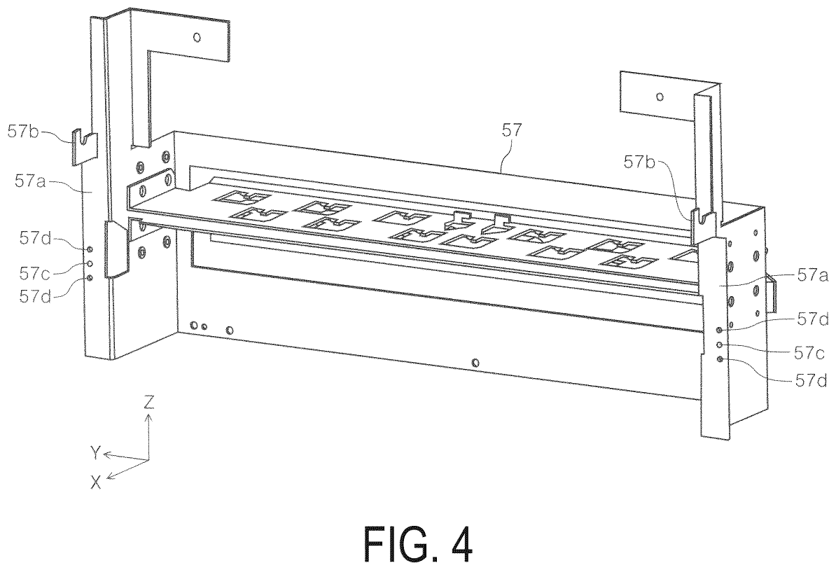

More specifically, the printer 1 includes the mounting frame 57 illustrated in FIG. 4. In the mounting frame 57, fixing portions 57a forming a surface parallel to the Y-Z plane are formed at intervals in the Y-axis direction. A boss 57c and a screw hole 57d are formed at the fixing portion 57a.

On the other hand, as illustrated in FIG. 3, a plurality of holes 61g are formed at the fixed portion 61e of the corrugation unit 60 at intervals along the Z-axis direction. The boss 57c of the mounting frame 57 can be fitted into any one of the holes 61g. Further, a screw (not illustrated) can be fitted into the screw hole 57d through any one of the holes 61g. Thus, the corrugation unit 60 can be fixed to the mounting frame 57.

Note that a hook portion 57b is formed at the fixing portion 57a of the mounting frame 57. A boss 61f is provided at the base frame 61 of the corrugation unit 60, and the boss 61fcan be caught by the hook portion 57b. That is, when the corrugation unit 60 is fixed to the mounting frame 57, the corrugation unit 60 can be first hooked on the hook portion 57b to be temporarily fixed, so that the corrugation unit 60 can be mounted with easy workability.

When the corrugation unit 60 is fixed at a plurality of height positions in the Z-axis direction as illustrated in FIGS. 1 and 2, a plurality of sets each including the hook portion 57b, the boss 57c, and the screw hole 57d are formed in the Z-axis direction.

Next, as illustrated in FIG. 3, coupling frames 62, 75 and 76 extending in the Y-axis direction are fixed to the side frame portions 61a and 61b of the base frame 61. Thus, rigidity of the base frame 61 is enhanced.

The coupling frame 76 is provided with a roller supporting member 77. The roller supporting member 77 is provided with a driving roller 65a constituting a discharge roller pair 65.

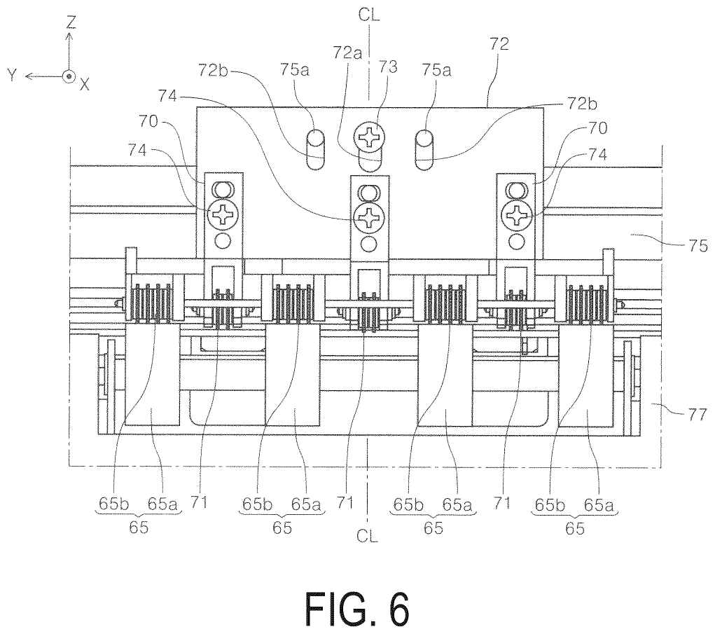

The discharge roller pair 65 is a roller pair that discharges the medium from the corrugation unit 60, and includes the driving roller 65a that is driven by a power source and a driven roller 65b (see FIG. 6) that is driven to rotate. A plurality of the discharge roller pairs 65 are provided at intervals along the medium width direction.

Next, the corrugation unit 60 includes a plurality of corrugation members 66 along the Y-axis direction, that is, the medium width direction. Note that the reference sign 66 of the corrugation member is added with a capital alphabet letter depending on an arrangement position in the medium width direction. A reference sign 66A denotes a corrugation member positioned on an innermost side in the medium width direction. A reference sign 66B denotes a corrugation member positioned on an outer side with respect to the corrugation member 66A in the medium width direction. A reference sign 66C denotes a corrugation member positioned on an outer side with respect to the corrugation member 66B in the medium width direction.

Note that, hereinafter, when the plurality of corrugation members are not distinguished from each other, the corrugation members are collectively referred to as the corrugation members 66.

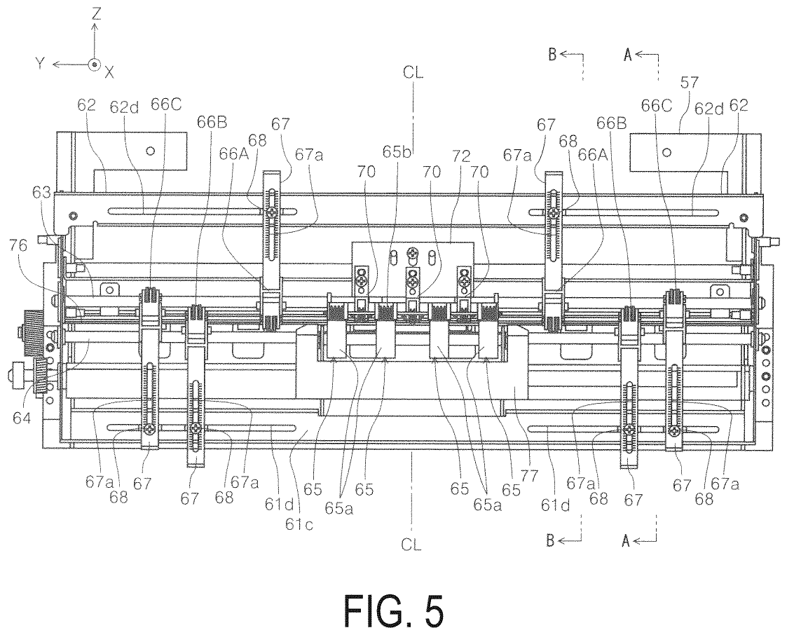

In FIG. 5, a reference sign CL denotes a center line in the medium width direction, and the center line CL is a center position in the medium width direction regardless of a medium size. The corrugation members 66 are disposed left and right with the center line CL as a center in the medium width direction. In particular, in FIG. 5, the corrugation members 66 are disposed at positions that are line-symmetric with respect to the center line CL in the medium width direction.

Note that the discharge roller pairs 65 are similarly disposed at positions that are line-symmetric with the center line CL as a center in the medium width direction. Further, driven rollers 71 (see FIG. 6) are similarly disposed at positions that are line-symmetric with the center line CL as a center in the medium width direction.

When an upper surface of the medium transported through the corrugation unit 60 is a first surface and a lower surface is a second surface, the corrugation member 66A faces the first surface of the medium and the corrugation members 66B and 66C face the second surface of the medium.

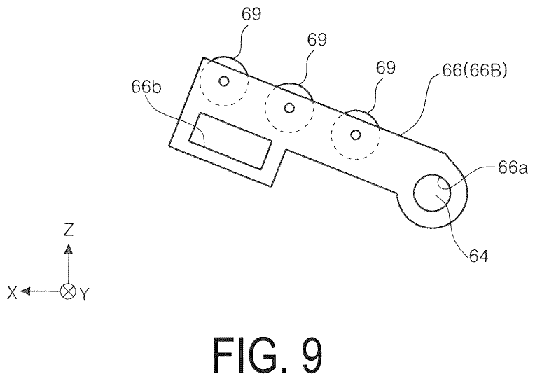

In the embodiment, the plurality of corrugation members 66 have the same structure, and hereinafter, the structure of the corrugation member 66 will be described using the corrugation member 66B illustrated in FIG. 9 as a representative example. A shaft hole 66a and an engagement groove 66b are formed at the corrugation member 66. The shaft hole 66a is a hole through which a first shaft 63 (see FIGS. 3 and 4) or a second shaft 64 (se FIGS. 3 and 4) passes. The corrugation member 66 is rotatable in the X-Z plane by the first shaft 63 or the second shaft 64 passing through the shaft hole 66a.

Note that the first shaft 63 and the second shaft 64 are shafts extending along the Y-axis direction and are supported by the side frame portions 61a and 61b. The corrugation member 66 is movable in the medium width direction while being guided by the first shaft 63 or the second shaft 64.

A plurality of driven rollers 69 are provided at the corrugation member 66 so as to be exposed from the corrugation member 66. In the embodiment, the driven roller 69 is a toothed roller including a plurality of teeth along an outer periphery thereof. In the embodiment, the three driven rollers 69 are provided along a medium transport direction. The corrugation member 66 can come into contact with the medium via the plurality of driven rollers 69.

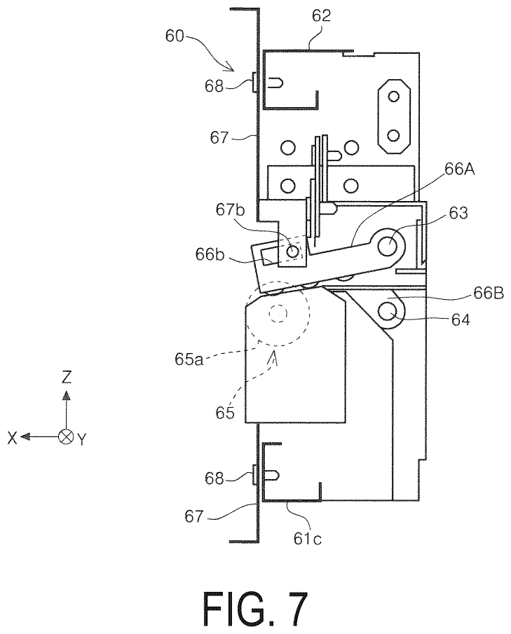

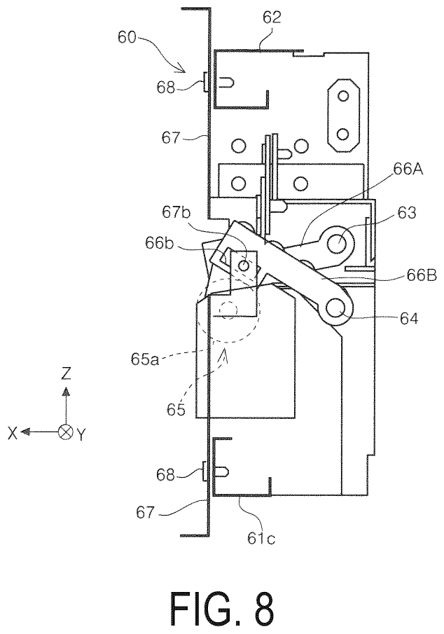

The engagement groove 66b is formed so as to extend in a radial direction from an axial center of the first shaft 63 or the second shaft 64. An engagement shaft 67b (see FIGS. 7 and 8) provided at the supporting member 67 (see FIGS. 3 and 4) is inserted into the engagement groove 66b. Since the engagement groove 66b is a long groove, the engagement shaft 67b is inserted into the engagement groove 66b with leeway being included.

Of the plurality of corrugation members 66, the corrugation member 66A is rotatable about the first shaft 63 as illustrated in FIG. 3, and rotation thereof about the first shaft 63 is restricted by being engaged with the supporting member 67. Further, of the plurality of corrugation members 66, the corrugation members 66B and 66C are rotatable about the second shaft 64 as illustrated in FIG. 3, and rotation thereof about the second shaft 64 is restricted by being engaged with the supporting members 67.

As described above, the supporting member 67 regulates a position of the corrugation member 66 in the Z-axis direction, that is, a height position.

Note that, hereinafter, a position of a constituent member of the corrugation unit 60 in the Z-axis direction may be referred to as a height position. Note that the Z-axis direction is an intersecting direction intersecting a surface of the medium discharged in the +X direction by the corrugation unit 60. The Y-axis direction, that is, the medium width direction is a direction along the surface of the medium and is a direction intersecting the +X direction.

As illustrated in FIG. 3, the supporting member 67 according to the embodiment has a shape extending in the Z-axis direction. An elongated hole 67a extending in the Z-axis direction is formed at the supporting member 67.

For example, a supporting member 67 supporting the corrugation member 66A is fixed to the coupling frame 62. A guide hole 62d extending in the medium width direction is formed at the coupling frame 62. The supporting member 67 is fixed to the coupling frame 62 by a screw 68 being inserted through the elongated hole 67a and the guide hole 62d, and by the screw 68 being fitted into a nut (not illustrated). This fixing includes fixing in the Y-axis direction, that is, the medium width direction, and fixing in the Z-axis direction, that is, the height direction.

Similarly, the supporting member 67 supporting the corrugation members 66B and 66C is fixed to a standing wall portion 61c. The standing wall portion 61c is a part of the base frame 61 and is a portion forming a surface parallel to the Y-Z plane. A guide hole 61d extending in the medium width direction is formed at the standing wall portion 61c. The supporting member 67 is fixed to the standing wall portion 61c by the screw 68 being inserted through the elongated hole 67a and the guide hole 61d, and by the screw 68 being fitted into a nut (not illustrated). This fixing includes fixing in the Y-axis direction, that is, the medium width direction, and fixing in the Z-axis direction, that is, the height direction.

Note that fine irregularities are formed at a surface of the supporting member 67, thereby suppressing a position shift of the supporting member 67 in the height direction at the time of fixing by the screw 68.

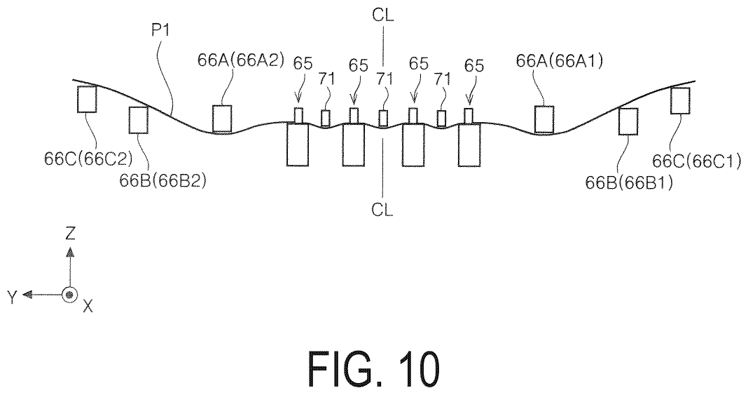

By the plurality of corrugation members 66 described above, it is possible to form a corrugated shape along the medium width direction as illustrated in FIGS. 10, 11, and 12 as an example.

Note that a reference sign 71 denotes a driven roller disposed between the discharge roller pairs 65 adjacent to each other in the medium width direction. The driven roller 71 is supported by a central corrugation member 70 as illustrated in FIG. 6. The central corrugation member 70 is fixed to a slider 72 by a screw 74.

The slider 72 is fixed to the coupling frame 75 by a screw 73. More specifically, a boss 75a is formed at the coupling frame 75. Elongated holes 72a and 72b elongated in the Z-axis direction are formed at the slider 72. The elongated holes 72b are formed on both sides of the elongated hole 72a. The screw 73 is fitted into a screw hole (not illustrated) of the coupling frame 75 via the long hole 72a. Further, the boss 75a of the coupling frame 75 enters the elongated hole 72b. With such a configuration, the slider 72 can slide in the Z-axis direction, that is, the height direction with respect to the coupling frame 75, and can be fixed at a predetermined height position by the screw 73.

By adjusting the position in the Z-axis direction of the slider 72, a height direction position of the driven roller 71 can be adjusted. A position at which the driven roller 71 comes into contact with the medium can be set to be below a medium nip position by the discharge roller pair 65. Accordingly, a corrugated shape can be formed in the medium as illustrated in FIGS. 10 to 12 by the discharge roller pair 65 and the driven roller 71.

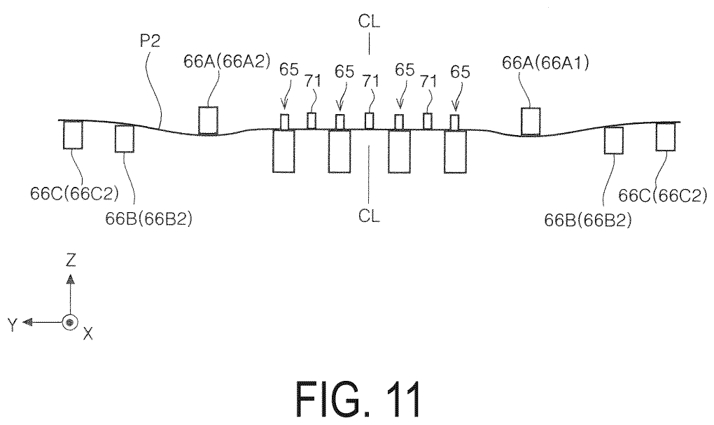

FIG. 10 illustrates a case where a corrugated shape is formed in plain paper Pl as an example. On the other hand, FIG. 11 illustrates a case where a corrugated shape is formed in thick paper P2 as an example. The thick paper P2 is thicker and more rigid than the plain paper P1. When an attempt is made to form a strong corrugated shape in such a medium, the medium is damaged and strong transporting force is required, thus there is a risk that a feed failure is caused. Therefore, in the case of the thick paper P2, it is suitable that the corrugated shape is made relatively gentler than that in the plain paper P1, or the corrugated shape is not formed.

In order to make the corrugated shape relatively gentle as compared with the case of FIG. 10 or not to form the corrugated shape, a height position of the corrugation member 66A is raised and height positions of the corrugation members 66B and 66C are lowered. Further, a height position of the driven roller 71 is raised. Accordingly, as illustrated in FIG. 11, a gentle corrugated shape can be formed at the a medium P2.

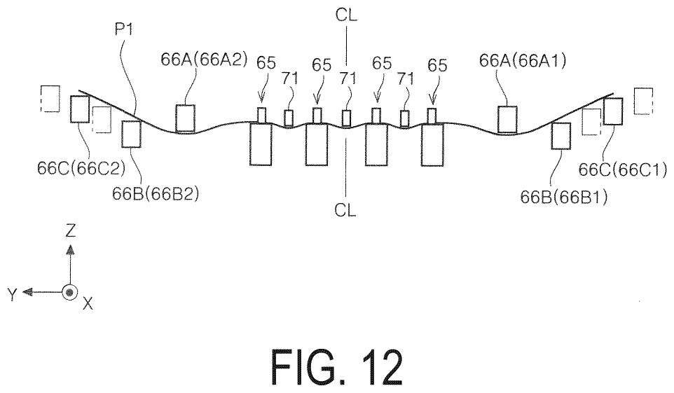

Next, FIG. 12 illustrates a case where plain paper P3 having a smaller size than that of the plain paper P1 is discharged. For example, in a state where the corrugation members 66B and 66C are located at the positions illustrated in FIG. 10, when a medium width direction size becomes small, there is a risk that side ends in the medium width direction cannot be appropriately supported and an appropriate corrugation cannot be formed. In FIG. 12, two-dot chain lines indicate the positions of the corrugation members 66B and 66C illustrated in FIG. 10. Therefore, by moving the corrugation members 66 in the medium width direction according to the medium width direction size, it is possible to form an appropriate corrugated shape in the medium.

As described above, the corrugation unit 60 includes the plurality of corrugation members 66 that come into contact with the medium transported in the +X direction being the transport direction and impart a corrugated shape to the medium. The position of the corrugation member 66 in the medium width direction and the position thereof in the height direction, which is an example of a direction intersecting the surface of the medium, are adjustable. Accordingly, it is possible to further increase the degree of freedom in forming a corrugated shape, and it is possible to more appropriately transport the medium.

In addition, in the embodiment, the corrugation unit 60 includes the supporting member 67 that is movable in the medium width direction and the height direction, and the standing wall portion 61c and the coupling frame 62 that are examples of a fixing member that fixes the supporting member 67. With such a configuration, it is possible to appropriately adjust and hold the positions of the corrugation member 66 in the medium width direction and the height direction.

In addition, in the embodiment, the corrugation unit 60 includes the first shaft 63 and the second shaft 64 that are shafts extending along the medium width direction and support the corrugation member 66 together with the supporting member 67. Then, the corrugation member 66 rotates about the first shaft 63 or the second shaft 64 to change the position in contact with the medium. With such a configuration, the position at which the corrugation member 66 comes into contact with the medium is stabilized, and it is possible to more appropriately form a corrugated shape in the medium.

Further, the corrugation member 66 and the supporting member 67 are engaged with each other by the engagement shaft 67b provided at the supporting member 67 and the engagement groove 66b provided at the corrugation member 66. Then, the leeway is provided between the engagement shaft 67b and the engagement groove 66b as illustrated in FIGS. 7 and 8. Accordingly, when the supporting member 67 is displaced in the height direction, it is possible to prevent the engagement shaft 67b from applying strong force to the engagement groove 66b. As a result, deformation of the supporting member 67 or the corrugation member 66 can be suppressed. Note that as a modification of the embodiment, the engagement shaft 67b may be provided at the corrugation member 66 and the engagement groove 66b may be provided at the supporting member 67.

In addition, the corrugation unit 60 according to the embodiment includes the driving roller 65a as a roller driven by a driving source and a transport roller that transports the medium.

In the configuration in which the corrugation member 66 imparts a corrugated shape to the medium, transport resistance occurs in the medium, however, the corrugation unit 60 includes the driving roller 65a driven by the driving source as described above, it is possible to appropriately transport the medium even when transport resistance is caused in the medium by the corrugation member 66.

Further, in the embodiment, as illustrated in FIGS. 7 and 8, the driving roller 65a and the corrugation member 66 overlap each other in the transport direction when viewed from the medium width direction. As a result, the driving roller 65a applies transport force to the medium at a position close to the corrugation member 66, thus the medium can be appropriately transported even when transport resistance is caused in the medium by the corrugation member 66.

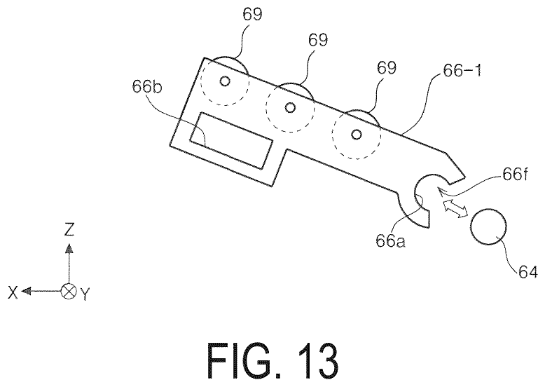

Note that as a modification of the corrugation member 66, it is suitable to configure the corrugation member 66 to be attachable to and detachable from the corrugation unit 60. A corrugation member 66-1 illustrated in FIG. 13 is an example of a detachable corrugation member and includes an opening portion 66f for receiving the second shaft 64. An opening width of the opening portion 66f is smaller than a shaft diameter of the second shaft 64. As an example, the corrugation member 66 is formed of a resin material, and when the shaft hole 66a is fitted into the second shaft 64, the opening portion 66f is widened by elastic deformation of a corrugation member 66-1 so that the shaft hole 66a can be fitted to the second shaft 64. Further, when the corrugation member 66-1 is removed from the second shaft 64, the opening portion 66f is widened by elastic deformation of the corrugation member 66-1, so that the corrugation member 66-1 can be removed from the second shaft 64.

According to such a configuration, the number of corrugation members 66 can be adjusted, and the degree of freedom in adjusting a corrugated shape to be imparted to the medium is improved.

Note that when the corrugation member 66 is attached to and detached from the corrugation unit 60, the first shaft 63 or the second shaft 64 may be made attachable to and detachable from the corrugation unit 60 instead of the configuration in which the corrugation member 66 is attachable to and detachable from the first shaft 63 or the second shaft 64.

In addition, in the embodiment, the plurality of corrugation members 66 include the corrugation member 66A as a first corrugation member coming into contact with the first surface of the medium and the corrugation members 66B and 66C as second corrugation members coming into contact with the second surface of the medium opposite the first surface. Accordingly, the degree of freedom in adjusting a corrugated shape to be imparted to the medium is improved.

In addition, in the embodiment, the printer 1 includes the mounting frame 57 constituting a base body of the device, and the corrugation unit 60 is attachable to and detachable from the mounting frame 57. The mounting frame 57 is an example of a mounting portion from which the corrugation unit 60 is detachable. Thus, by removing the corrugation unit 60 when unnecessary, the installation space of the device can be reduced, thereby improving usability.

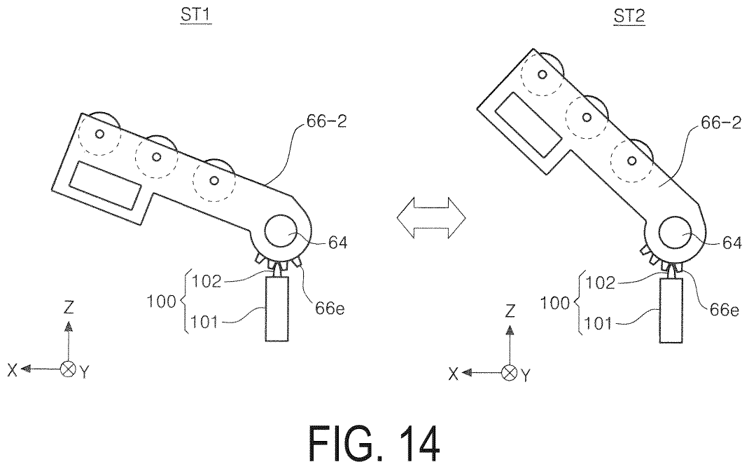

Note that in the above-described embodiment, the height position of the corrugation member 66 is adjusted by moving the supporting member 67 up and down, but the present disclosure is not limited thereto. For example, the corrugation member 66-2 illustrated in FIG. 14 includes a plurality of tooth portions 66e around the second shaft 64. A plunger 100 is provided at a position facing the tooth portions 66e. The plunger 100 includes a main body 101 and a pin 102 that can elastically advance and retreat with respect to the main body 101. A height direction position of the corrugation member 66-2 is regulated by the pin 102 engaging with the toothed portion 66e. Then, as illustrated by a change between a state ST1 and a state ST2, the height direction position of the corrugation member 66-2 is switched by a position at which the pin 102 meshes with the toothed portion 66e being switched.

Needless to say, such a configuration may be applied to the first shaft 63 and the corrugation member 66 supported by the first shaft 63. Further, such a configuration may be applied to all or only some of the plurality of corrugation members 66.

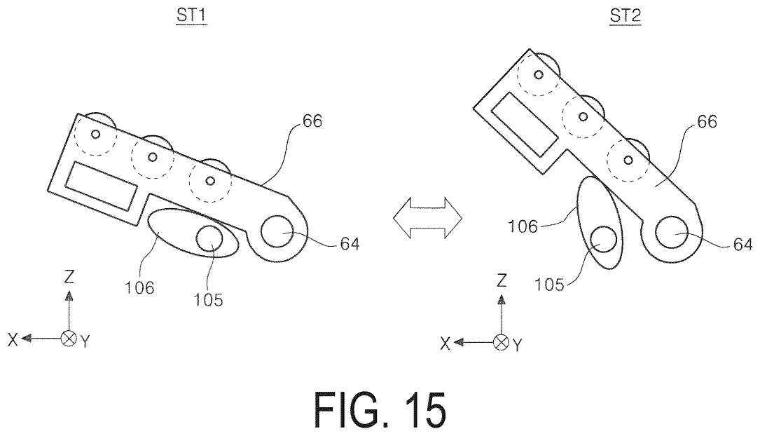

Further, in the configuration illustrated in FIG. 15, the height direction position of the corrugation member 66 is regulated by a cam 106. The cam 106 is a so-called eccentric cam, and is provided at a cam shaft 105. The cam 106 supports the corrugation member 66. The cam shaft 105 is driven by a motor (not illustrated). When the cam 106 is rotated by rotation of the cam shaft 105, the height direction position of the corrugation member 66 is switched as illustrated by the change between state ST1 and state ST2.

Needless to say, such a configuration may be applied to the first shaft 63 and the corrugation member 66 supported by the first shaft 63. Further, such a configuration may be applied to all or only some of the plurality of corrugation members 66.

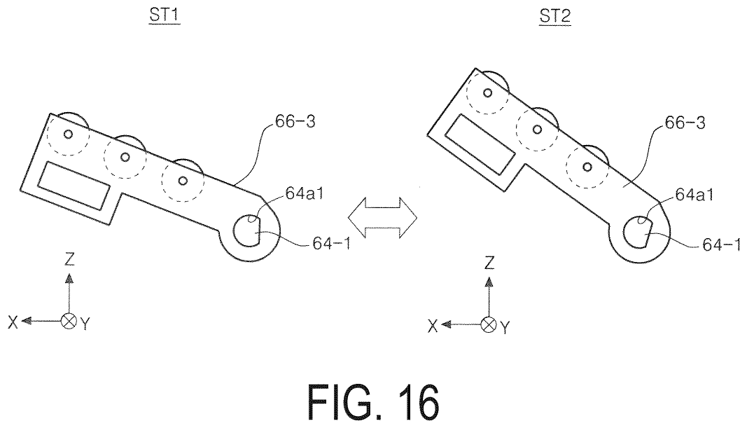

In addition, in the configuration illustrated in FIG. 16, a second shaft 64-1 is used instead of the second shaft 64 described above. The second shaft 64-1 has a D-cut shape, and a shaft hole 64a1 of a corrugation member 66-3 has a shape corresponding to the D-cut shape. The second shaft 64-1 is driven by a motor (not illustrated). When the second shaft 64-1 rotates, a height direction position of the corrugation member 66-3 is switched as illustrated by a change between state ST1 and state ST2. Note that the corrugation member 66-3 is slidable in an axial direction with respect to the second shaft 64-1.

Needless to say, such a configuration may be applied to the first shaft 63 and the corrugation member 66 supported by the first shaft 63. Further, such a configuration may be applied to all or only some of the plurality of corrugation members 66.

Note that in the embodiments illustrated in FIGS. 15 and 16, the height direction positions of the plurality of corrugation members 66 provided along the medium width direction can be changed in conjunction with each other. For example, height positions of the two corrugation members 66A can be changed in conjunction with each other. Accordingly, it is possible to appropriately impart a corrugated shape to the medium.

Note that in the configuration including the corrugation member 66A, that is, the first corrugation member coming into contact with the first surface of the medium, and the corrugation members 66B and 66C, that is, the second corrugation members coming into contact with the second surface of the medium, the following aspects can be adopted. That is, it is also possible that height positions of either the first corrugation members or the second corrugation members or of both are changeable in conjunction with each other.

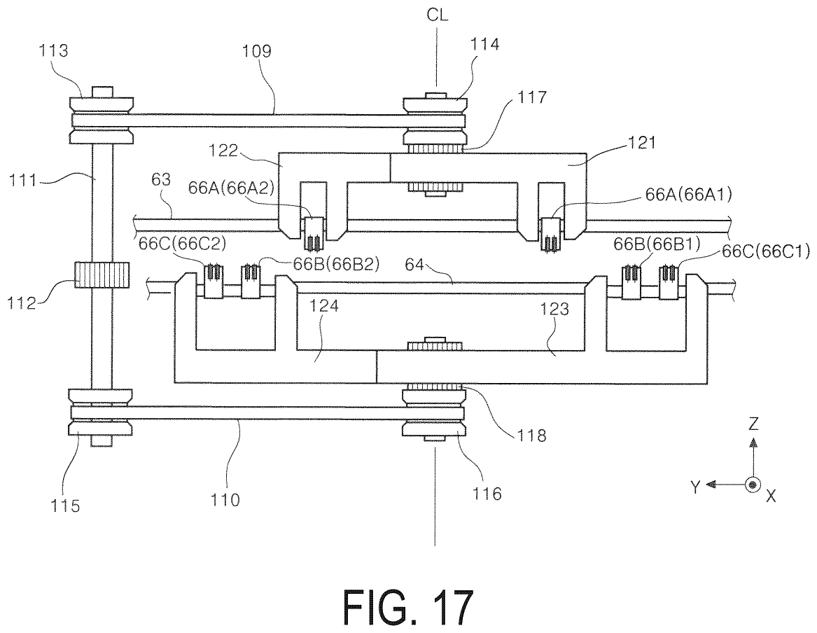

Next, a configuration in which a plurality of the corrugation members 66 interlock will be described with reference to FIGS. 17 to 19.

Note that in the embodiment, the plurality of corrugation members 66 include right corrugation members (reference signs 66A1, 66B1, and 66C1 in FIGS. 10 to 12) positioned on a right side (the −Y direction) of a center position in the width direction of the medium and left corrugation members (reference sings 66A2, 66B2, and 66C2 in FIGS. 10 to 12) positioned on a left side (the +Y direction) of the center position.

Note that “right” and “left” in this case are for convenience and may be reversed when the viewing direction is changed.

The right corrugation member 66A1 is provided at a first rack member 121. The left corrugation member 66A2 is provided at a second rack member 122. A rack portion 121a is formed at the first rack member 121, and a rack portion 122a is formed at the second rack member 122. A pinion 117 meshes with the rack portion 121a and the rack portion 122a to constitute a rack-and-pinion mechanism.

The right corrugation members 66B1 and 66C1 are provided at a third rack member 123. The left corrugation members 66B2 and 66C2 are provided at a fourth rack member 124. Rack portions (not illustrated) are formed at the third rack member 123 and the fourth rack member 124, and a pinion 118 meshes with these rack portions to constitute a rack-and-pinion mechanism.

A pulley 114 is integrally provided at the pinion 117. Further, a shaft 111 is provided with a pulley 113, and an endless belt 109 is wound around the pulley 113 and the pulley 114.

Similarly, the pinion 118 is integrally provided with a pulley 116. Further, the shaft 111 is provided with a pulley 115, and an endless belt 110 is wound around the pulley 115 and the pulley 116.

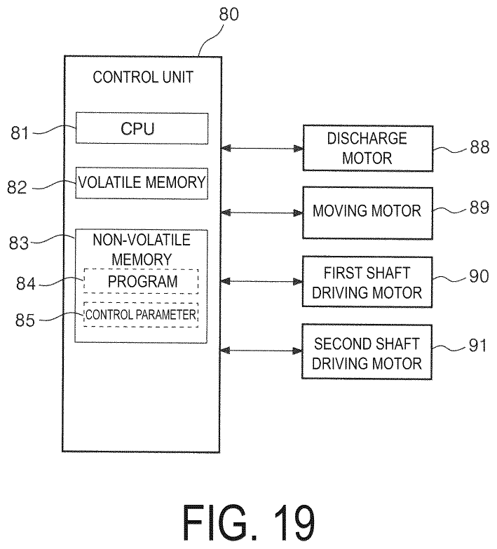

The shaft 111 is rotatable and is provided with a toothed gear 112. Power of a moving motor 89 (see FIG. 19) is transmitted to the toothed gear 112, and when the shaft 111 rotates, the endless belts 109 and 110 are rotated.

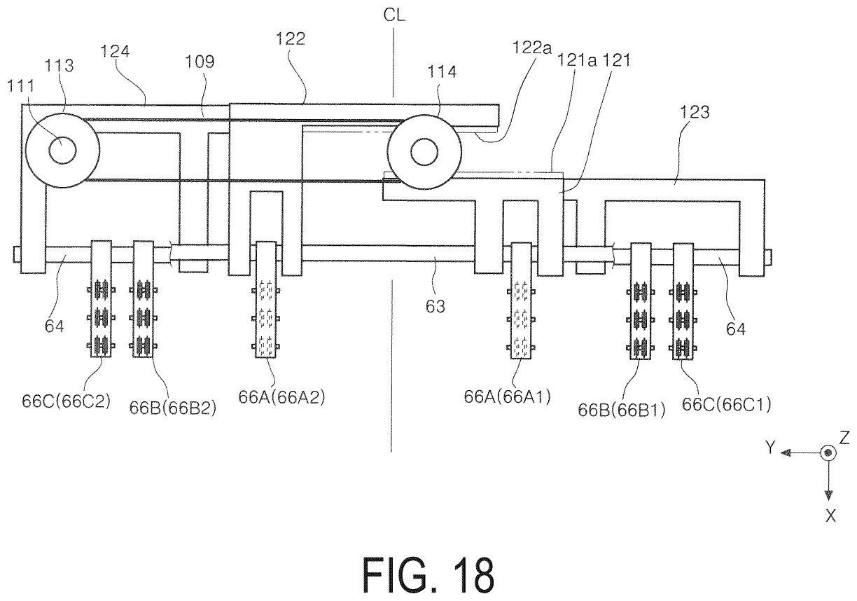

For example, when the shaft 111 rotates in a clockwise direction in FIG. 18, the first rack member 121, that is, the right corrugation member 66A1, and the third rack member 123, that is, the right corrugation members 66B1 and 66C1, move in the +Y direction. Further, when the shaft 111 rotates in the clockwise direction in FIG. 18, the second rack member 122, that is, the left corrugation member 66A2, and the fourth rack member 124, that is, the left corrugation members 66B2 and 66C2, move in the −Y direction.

Further, when the shaft 111 rotates in a counterclockwise direction in FIG. 18, the first rack member 121, that is, the right corrugation member 66A1, and the third rack member 123, that is, the right corrugation members 66B1 and 66C1, move in the-Y direction. Further, when the shaft 111 rotates in the counterclockwise direction in FIG. 18, the second rack member 122, that is, the left corrugation member 66A2, and the fourth rack member 124, that is, the left corrugation members 66B2 and 66C2, move in the +Y direction.

As described above, the right corrugation members (denoted by the reference signs 66A1, 66B1, and 66C1 in FIGS. 10 to 12) and the left corrugation members (denoted by the reference signs 66A2, 66B2, and 66C2 in FIGS. 10 to 12) are provided so as to approach and separate from each other in the medium width direction.

As a result, the right corrugation members and the left corrugation members are disposed at positions that are constantly symmetrical with respect to the center position in the medium width direction, and it is possible to appropriately impart a corrugated shape to the medium.

Note that in the embodiment, the height position of the corrugation member 66 can be adjusted by rotating the first shaft 63 and the second shaft 64 as in the embodiment illustrated in FIG. 16. In FIG. 19, a first shaft driving motor 90 is a driving source of the first shaft 63, and a second shaft driving motor 91 is a driving source of the second shaft 64. The first shaft driving motor 90 rotates the first shaft 63 via a power transmission unit (not illustrated). The second shaft driving motor 91 rotates the second shaft 64 via a power transmission unit (not illustrated). Note that in the configuration in which the first shaft 63 and the second shaft 64 are rotated, it is suitable that a worm gear mechanism or the like is interposed in the above power transmission unit so that the height position of the corrugation member 66 is not varied by external force received from the medium.

As described above, the position of the corrugation member 66 in the medium width direction and the position thereof in a direction intersecting the surface of the medium can be adjusted by the movement unit. The movement unit can include the width direction movement unit for adjusting the position of the corrugation member 66 in the medium width direction and the intersecting direction movement unit for adjusting the position in a direction intersecting the surface of the medium.

Although the width direction movement unit includes the rack-and-pinion mechanism in the above-described example, for example, the corrugation member 66 may be directly moved in the medium width direction by an endless belt, a ball screw, or the like. In addition, for example, the corrugation member 66 may be moved in the medium width direction by a user rotating the shaft 111 without depending on the power of the motor.

Additionally, although the intersecting direction movement unit is configured to rotate the first shaft 63 and the second shaft 64 in the above-described example, the cam mechanism as described with reference to FIG. 15 may be used to move the corrugation member 66 in a direction intersecting the surface of the medium. In addition, the intersecting direction movement unit may be configured such that, for example, the user rotates the first shaft 63 and the second shaft 64 without depending on the power of the motor.

Here, a control unit 80 will be described with reference to FIG. 19.

The control unit 80 performs various controls including recording control in the printer 1. Note that FIG. 19 only illustrates constituent elements necessary for describing the embodiment, and does not illustrate other constituent elements.

The control unit 80 controls a discharge motor 88, the moving motor 89, the first shaft driving motor 90, and the second shaft driving motor 91. Each of the motors is a DC motor as an example. Each of the motors is provided with rotary encoders (not illustrated), and the control unit 80 can detect a rotation direction, rotation amount, and rotation speed of each of the motors using these rotary encoders. That is, the control unit 80 can detect a drive direction, a drive amount, and a drive speed of each drive object.

The discharge motor 88 is a driving source of the driving roller 65a constituting the discharge roller pair 65. The discharge motor 88 may be provided at a main body of the printer 1, or may be provided at the corrugation unit 60. When the discharge motor 88 is provided at the main body of the printer 1, the corrugation unit 60 obtains power of the discharge motor 88 from the main body of the printer 1 via a power coupling unit (not illustrated). In addition, when the discharge motor 88 is provided at the corrugation unit 60, the corrugation unit 60 obtains electric power from the main body of the printer 1 via a coupling portion (not illustrated).

Similarly, the first shaft driving motor 90 and the second shaft driving motor 91 may be provided at the main body of the printer 1 or may be provided at the corrugation unit 60.

The control unit 80 includes a CPU 81 that executes a computer program, in other words, software, a volatile memory 82, and a non-volatile memory 83. The CPU 81 performs various calculations required to execute a program 84 stored in the non-volatile memory 83. The volatile memory 82 is used as a temporary data storage area. The non-volatile memory 83 stores the program 84 and control parameters 85 required to execute the program 84. Various processes to be described later are realized by the control unit 80 executing the program 84.

The control unit 80 drives each motor based on a medium type and medium size information included in recorded data, and adjusts the width direction position and the height direction position of the corrugation member 66 as described with reference to FIGS. 10 to 12.

Note that when strength of a corrugation is excessive for a thickness of the medium, a load of transport by the discharge roller pair 65 increases. Therefore, when a driving current value of the discharge motor 88 exceeds a predetermined threshold value, the control unit 80 can also control each motor so as to weaken the strength of the corrugation. For example, when the drive current value of discharge motor 88 exceeds the predetermined threshold value in the state illustrated in FIG. 10, a position of corrugation member 66 can be changed as illustrated in FIG. 11.

The present disclosure is not limited to the embodiments and modifications described above, and it is obvious that various modifications are possible within the scope of the disclosure described in the claims, and these are also included in the scope of the present disclosure.

What is claimed is:

1. A medium transport device, comprising:
a corrugation unit including a plurality of corrugation members that come into contact with a medium transported in a transport direction and impart a corrugated shape to the medium; and
a transport path through which the medium is transported, wherein
when a direction along a surface of the medium and intersecting the transport direction is a width direction, and a direction intersecting the surface of the medium is an intersecting direction,
a position of the corrugation member in the width direction and a position in the intersecting direction are adjustable.

2. The medium transport device according to claim 1, wherein
the corrugation unit includes
a supporting member that is a member for supporting the corrugation member and is movable in the width direction and the intersecting direction and
a fixing member for fixing the supporting member.

3. The medium transport device according to claim 2, wherein
the corrugation unit includes a shaft that extends along the width direction, the shaft supporting the corrugation member together with the supporting member, and
the corrugation member changes a position in contact with the medium by rotating around the shaft.

4. The medium transport device according to claim 3, wherein
the corrugation member and the supporting member are engaged with each other by an engagement shaft provided on one side and an engagement groove provided on another side, and
leeway is provided between the engagement shaft and the engagement groove.

5. The medium transport device according to claim 1, wherein
the corrugation unit includes a transport roller that is a roller driven by a driving source and transports the medium.

6. The medium transport device according to claim 5, wherein
the transport roller and the corrugation member overlap each other in the transport direction when viewed from the width direction.

7. The medium transport device according to claim 1, wherein
the corrugation member is attachable to and detachable from the corrugation unit.

8. The medium transport device according to claim 1, wherein
a plurality of the corrugation members include
a first corrugation member coming into contact with a first surface of the medium and
a second corrugation member coming into contact with a second surface of the medium opposite to the first surface.

9. The medium transport device according to claim 8, wherein
the corrugation member is attachable to and detachable from the corrugation unit.

10. The medium transport device according to claim 1, wherein
a plurality of the corrugation members include
a right corrugation member positioned on a right side with respect to a center position in the width direction of the medium and
a left corrugation member positioned on a left side with respect to the center position, and
the right corrugation member and the left corrugation member are provided so as to approach and separate from each other in the width direction.

11. The medium transport device according to claim 8, wherein
a plurality of at least one of the first corrugation members and the second corrugation members are provided along the width direction, and
have positions changing in the intersecting direction in conjunction with each other.

12. The medium transport device according to claim 1, comprising a frame included in a base body of the device, wherein
the corrugation unit is attachable to and detachable from the frame.

13. A corrugation unit comprising a plurality of corrugation members that come into contact with a medium transported in a transport direction and impart a corrugated shape to the medium, wherein
when a direction along a surface of the medium and intersecting the transport direction is a width direction, and a direction intersecting the surface of the medium is an intersecting direction,
a position of the corrugation member in the width direction and a position in the intersecting direction are adjustable.

14. A medium transport device including a transport path through which a medium is transported, the medium transport device comprising a mounting portion to which the corrugation unit according to claim 13 is detachably attached.

15. A recording device, comprising:
a recording unit configured to perform recording on a medium; and
the medium transport device according to claim 1.
